(19) United States
(12) Patent Application Publication
(10) Pub. No.: US 2009/0235791 A1
(43) Pub. Date: Sep. 24, 2009

(54) SUCTION UNIT AND HEAT EXCHANGE FIN MANUFACTURING MACHINE

(76) Inventors: Masashi ENDO, Tokyo (JP); Makoto IWASAKI, Tokyo (JP)

Correspondence Address: BIRCH STEWART KOLASCH & BIRCH, PO BOX 747, FALLS CHURCH, VA, 22040-0747, US

(21) Appl. No.: 12/349,592

(22) Filed: Jan. 7, 2009

(30) Foreign Application Priority Data
Mar. 19, 2008 (JP) 2008-072511

(51) Int. Cl. B26D 7/06; B26D 7/27

(52) U.S. Cl. 83/100; 83/84

(57) ABSTRACT

The suction unit of the present invention comprises: a cylindrical member having a sucking section capable of sucking an elongated piece having faced the sucking section, an opening section being opened at a prescribed position at which the elongated piece is prohibited to face the opening section, and a suction unit for sucking air from the sucking section and the opening section; a blocking plate being moved without contacting the cylindrical member, the blocking plate prohibiting the air suction from the opening section when the elongated piece faces the sucking section, the blocking plate allowing the air suction from the opening section when the elongated piece sucked by the sucking section is cut and formed into the heat exchange fin; and a control section controlling the electric motor so as to place the blocking plate at a sucking position when the elongated piece faces the sucking section and at a releasing position when the elongated piece is cut and formed into the heat exchange fin.

### BACKGROUND OF THE INVENTION

The present invention relates to a suction unit and a heat exchange fin manufacturing machine, more precisely relates to a suction unit, which is used in a heat exchange fin manufacturing machine cutting a band-shaped metal thin plate to form into heat exchange fins having a prescribed length, each of which has a plurality of collared through-holes, and which feeds the heat exchange fins to a stacking unit, and a heat exchange fin manufacturing machine equipped with the suction unit.

A heat exchange fin of a heat exchanger, e.g., air conditioner, is a rectangular metal thin plate, in which a plurality of collared through-holes, into which heat exchange tubes will be inserted, are formed and arranged in the longitudinal direction. The heat exchange fin may be manufactured by, for example, a machine disclosed in Japanese Patent Gazette No. 2002-178065.

An outline of the heat exchange fin manufacturing machine is shown in FIG. 5. In the machine shown in FIG. 5, a band-shaped thin metal plate 100 is extended from a coil thereof and fed to a press unit 104. In the press unit 104, a plurality of collared through-holes are formed in the band-shaped metal thin plate 100, and then the band-shaped metal thin plate 100 is cut and formed into the heat exchange fin having a prescribed length by a cutter 106. The heat exchange fin is once sucked by a suction unit 108 attached to the press unit 104, and then accommodated in a stacking unit 110.

As shown in FIG. 6, the suction unit 108 has a cylindrical member 114, in which a sucking section 112 for sucking the heat exchange fin is formed in a bottom face. A perforated plate, in which a number of through-holes are bored, is attached to the sucking section 112.

Further, opening sections 116 are formed in an outer circumferential face of the cylindrical member 114. Blocking plates 118 are respectively rotatably provided to the opening sections 116, and the opening sections 116 are closed when end sections of the blocking plates 118 contact edges of the opening sections 116. The blocking plates 118 are rotated in the same direction by cylinder units (not shown).

An exhaust fan 122, which is driven by a motor 120, is attached to an upper part of the cylindrical member 114 and connected to an exhaust duct 124. With this structure, by driving the exhaust fan 122, air is sucked from the sucking section 112 and the opening sections 116 and discharged outside from an outlet 126 of the exhaust duct 124.

In the suction unit 108 shown in FIG. 6, by driving the exhaust fan 122 and actuating the cylinder units (not shown) so as to turn the blocking plates 118 until the end sections of the blocking plates 118 contact the edges of the opening sections 116 as shown in FIG. 7A, the opening sections 116 are closed. Therefore, air is substantially sucked from the sucking section 112 only, so that the heat exchange fin cut from the band-shaped metal thin plate 100 can be sucked and held by the sucking section 112.

On the other hand, by actuating the cylinder units (not shown) so as to turn the blocking plates 118 and open the opening sections 116 as shown in FIG. 7B, air can be sucked from the opening sections 116 only so that no air is sucked from the sucking section 112. Therefore, the heat exchange fin, which has been sucked and held by the sucking section 112, is released and falls by own weight, so that the heat exchange fin can be accommodated in the stacking unit 110.

These days, a rotational speed of the press unit 104 has been increased so as to increase a manufacturing efficiency of the heat exchange fin manufacturing machine.

The manufacturing efficiency of the heat exchange fin must be increased, but speeding up the conventional suction unit 108 is limited.

Further, by increasing the manufacturing efficiency of the heat exchange fin, number of making the blocking plate 118 contact with the cylindrical member 114 must be increased, so problems of durability issue and noise occur.

### SUMMARY OF THE INVENTION

The present invention was conceived to solve the above described problems.

An object of the present invention is to provide a suction unit, which is capable of solving the problems of the conventional suction unit (i.e., lower speed with respect to a processing speed of the press unit, durability issue, noise), matching an operation speed of the suction unit with processing speeds of the press unit, etc. and improving manufacturing efficiency of a heat exchange fin manufacturing machine.

Another object is to provide a heat exchange fin manufacturing machine including the suction unit of the present invention.

The inventors have studied to solve the problems and found that it was effective to rotate or swing a blocking plate, by an electric motor, without contacting a cylindrical member of a suction unit, so as to open and close an opening section of the cylindrical member.

The inventors have further studied the rotatable or swingable blocking plate and found that an elongated piece cut from a band-shaped metal thin plate could be sucked, toward a sucking section of the cylindrical member, by closing the opening section with the blocking plate when the elongated piece faced the sucking section, and that a heat exchange fin could be released from the sucking section by rotating or swinging the blocking plate until opening the opening section when the elongated piece was cut and formed into the heat exchange fin.

Further, by using such a blocking plate, a processing speed of the suction unit could be accelerated, and the problems of durability issue and noise could be solved.

To achieve the objects, the present invention has following structures.

Namely, the suction unit of the present invention, which is used in a heat exchange fin manufacturing machine cutting a band-shaped metal thin plate to form into heat exchange fins of a prescribed length, each of which has a plurality of collared through-holes, and which feeds the heat exchange fins to a stacking unit, comprises:

a cylindrical member having a sucking section, which is opened at a prescribed position, at which an elongated piece formed by cutting the band-shaped metal thin plate can face the sucking section, and which is capable of sucking the elongated piece having faced the sucking section, an opening section being opened at a prescribed position, at which the elongated piece is prohibited to face the opening section, and a suction unit for sucking air from the sucking section and the opening section;

a blocking plate being moved, by an electric motor, without contacting the cylindrical member, the blocking plate prohibiting the air suction from the opening section so as to suck the elongated piece by the sucking section when the elongated piece faces the sucking section, the blocking plate allowing the air suction from the opening section so as to feed the heat exchange fin to the stacking unit when the elongated piece sucked by the sucking section is cut and formed into the heat exchange fin having the prescribed length; and

a control section controlling the electric motor so as to place the blocking plate at a sucking position when the elongated piece faces the sucking section and at a releasing position when the elongated piece is cut and formed into the heat exchange fin.

The heat exchange fin manufacturing machine of the present invention comprises:

a press unit forming a plurality of collared through-holes in a band-shaped metal thin plate and cutting the band-shaped metal thin plate to form into heat exchange fins having a prescribed length;

a stacking unit stacking the heat exchange fins; and

the above described suction unit of the present invention.

In the suction unit, the blocking plate may be capable of opening and closing the opening section. With this structure, sucking air from the opening section can be securely performed and stopped.

In the suction unit, a plurality of the blocking plates may be provided and synchronously moved. With this structure, sucking the elongated piece by the sucking section and releasing the heat exchange fin therefrom can be rapidly performed.

In the suction unit, the blocking plate may be rotated or swung. For example, the rotary blocking plate may be rotated in one direction. In this case, the processing speed of the suction unit can be further accelerated Preferably, the electric motor may be a servo motor.

In the suction unit of the present invention, the blocking plate is moved by the electric motor without contacting the cylindrical member, so that the air suction from the opening section is prohibited so as to suck the elongated piece of the metal thin plate by the sucking section when the elongated piece faces the sucking section, and the air suction from the opening section is allowed so as to release the heat exchange fin from the sucking section when the elongated piece sucked by the sucking section is cut and formed into the heat exchange fin.

Therefore, the processing speed of the suction unit of the present invention can be higher than that of the conventional suction unit, in which the blocking plate is driven by the cylinder unit, so that processing speeds of the press unit, etc. can be accelerated.

Further, the blocking plate is moved without contacting the cylindrical member, so that durability of the blocking plate and the cylindrical member can be improved and the problem of noise can be prevented.

### BRIEF DESCRIPTION OF THE DRAWINGS

Embodiments of the present invention will now be described by way of examples and with reference to the accompanying drawings, in which:

FIG. 1 is an explanation view of a heat exchange fin manufacturing machine having the suction unit of the present invention;

FIG. 2 is a front view of an embodiment of the suction unit of the present invention;

FIG. 3 is an explanation view of a rotary blocking plate used in the suction unit shown in FIG. 1;

FIGS. 4A and 4B are explanation views showing actions of the rotary blocking plate shown in FIG. 3;

FIG. 5 is an explanation view of the conventional heat exchange fin manufacturing machine;

FIG. 6 is an explanation view of the suction unit used in the conventional heat exchange fin manufacturing machine shown in FIG. 5; and

FIGS. 7A and 7B are explanation views showing actions of the conventional blocking plate shown in FIG. 6.

### DETAILED DESCRIPTION OF THE EMBODIMENTS

Preferred embodiments of the present invention will now be described in detail with reference to the accompanying drawings.

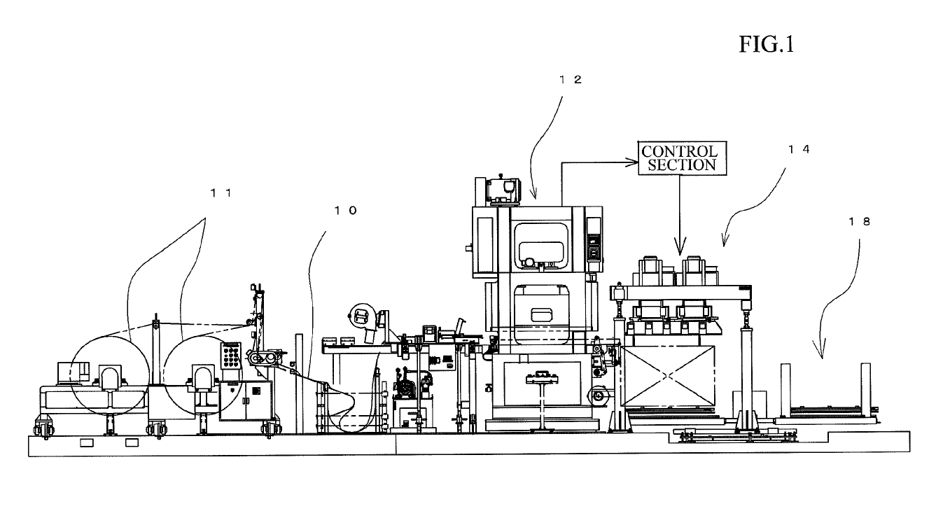

FIG. 1 shows an embodiment of a heat exchange fin manufacturing machine having a suction unit of the present invention. In the heat exchange fin manufacturing machine shown in FIG. 1, a band-shaped metal thin plate is wound as a coil 11, and the band-shaped metal thin plate 10 extended from the coil 11 is tensioned and fed to a press unit 12. In the press unit 12, a number of collared through-holes are formed in the fed metal thin plate 10 by dies, and then the metal thin plate 10 is cut by a cutter (not shown) of the press unit 12 and formed into a plurality of elongated pieces, each of which has a prescribed width. The elongated pieces are fed to a suction unit 14 in order. When the elongated piece is fed a prescribed length to the suction unit 14, the fed part of the elongated piece is cut by another cutter (not shown) of the press unit 12 so as to form a heat exchange fin having the prescribed length.

The suction unit 14 sucks and holds the elongated piece of the metal thin plate 10, and the heat exchange fin cut from the elongated piece is released from the suction unit 14 and fed to a stacking unit 18. A control section controls the suction unit 14 so as to synchronously perform the sucking and releasing actions with actions of the press unit 12.

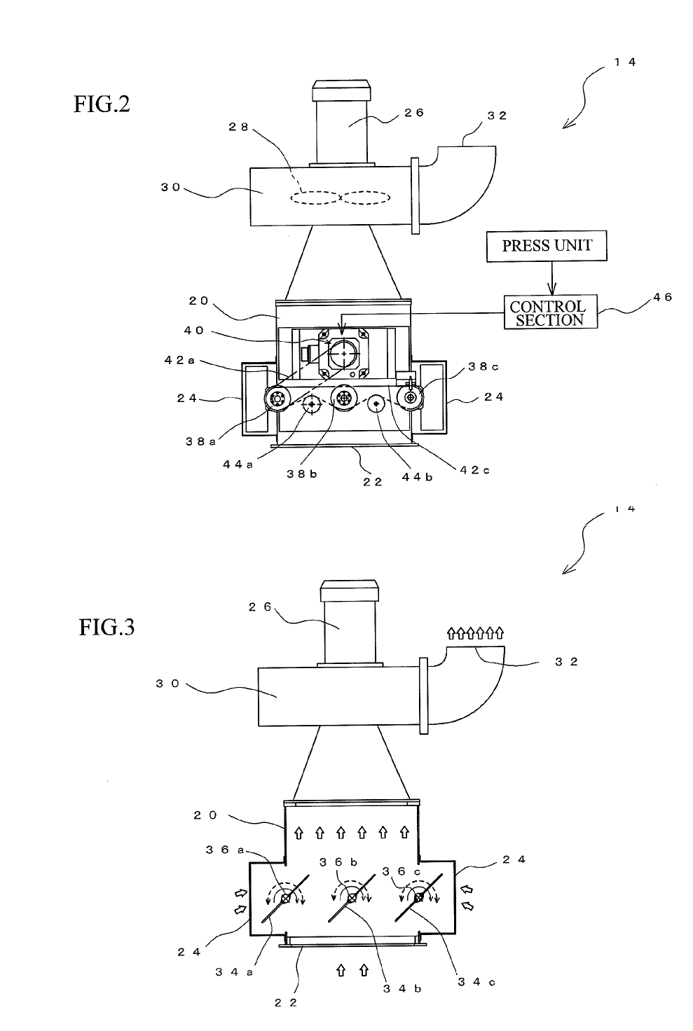

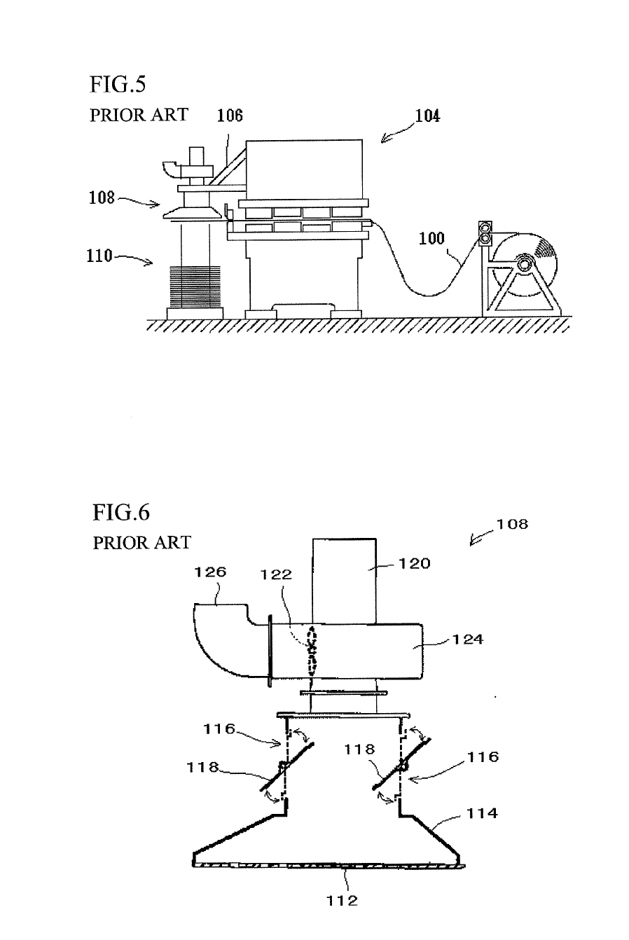

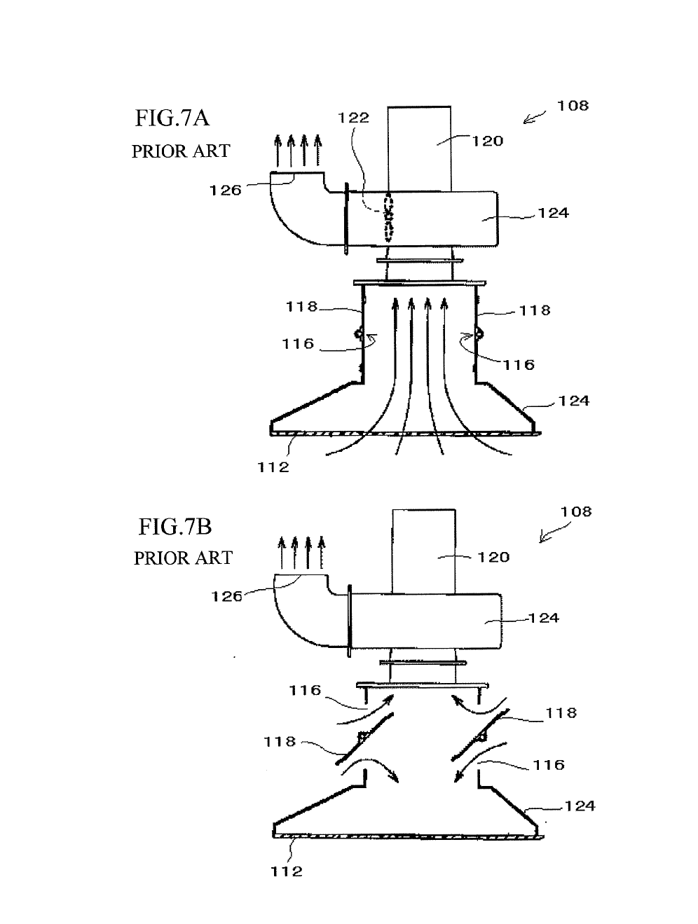

As shown in FIG. 2, the suction unit 14 shown in FIG. 1 has a cylindrical member 20, in which a sucking section 22 is formed in a bottom face and opening sections 24 are formed in an outer circumferential face. A perforated plate, in which a number of through-holes are bored, is attached to the sucking section 22 as well as the conventional suction unit 108 shown in FIG. 6.

An exhaust fan 28, which is driven by a motor 26, is attached to an upper part of the cylindrical member 20 and connected to an exhaust duct 30. With this structure, by driving the exhaust fan 28, air is sucked from the sucking section 22 and the opening sections 24 and discharged outside from an outlet 32 of the exhaust duct 30.

As shown in FIG. 3, rotary blocking plates 34a, 34b and 34c, which are respectively attached to shafts 36a, 36b and 36c spanned in the cylindrical member 20 and can be rotated in one rotational direction, are provided above the sucking section 22 of the cylindrical member 20. The rotary blocking plates 34a, 34b and 34c are arranged along the sucking section 22. The rotary blocking plates 34a, 34b and 34c can be rotated without contacting not only the adjacent rotary blocking plates but also an inner circumferential face of the cylindrical member 20. The rotary blocking plates 34a and 34c are capable of respectively closing the opening sections 24.

Ends of the shafts 36a, 36b and 36c, to which the rotary blocking plates 34a, 34b and 34c are respectively attached, are outwardly projected form the outer circumferential face of the cylindrical member 20. As shown in FIG. 2, pulleys 38a, 38b and 38c are respectively attached to the projected ends of the shafts 36a, 36b and 36c.

A servo motor 40, which is an example of an electric motor, is provided to the upper part of the cylindrical member 20, in which the pulleys 38a, 38b and 38c are attached. A power of the servo motor 40 is transmitted to the pulley 38a by a belt 42a. Further, the power transmitted to the pulley 38a is transmitted to the pulleys 38b and 38c by a belt 42b, which is engaged with the pulleys 38a, 38b and 38c.

In FIG. 3, the pulleys 38a, 38b and 38c are synchronously driven by the servo motor 40 and the belts 42a and 42b, so that the rotary blocking plates 34a, 34b and 34c are synchronously rotated in a direction indicated by arrows of by solid lines.

Note that, prescribed tension is given to the belt 42b engaged with the pulleys 38a, 38b and 38c by a tension pulley 44a, which is provided between the pulleys 38a and 38b, and a tension pulley 44b, which is provided between the pulleys 38b and 38c.

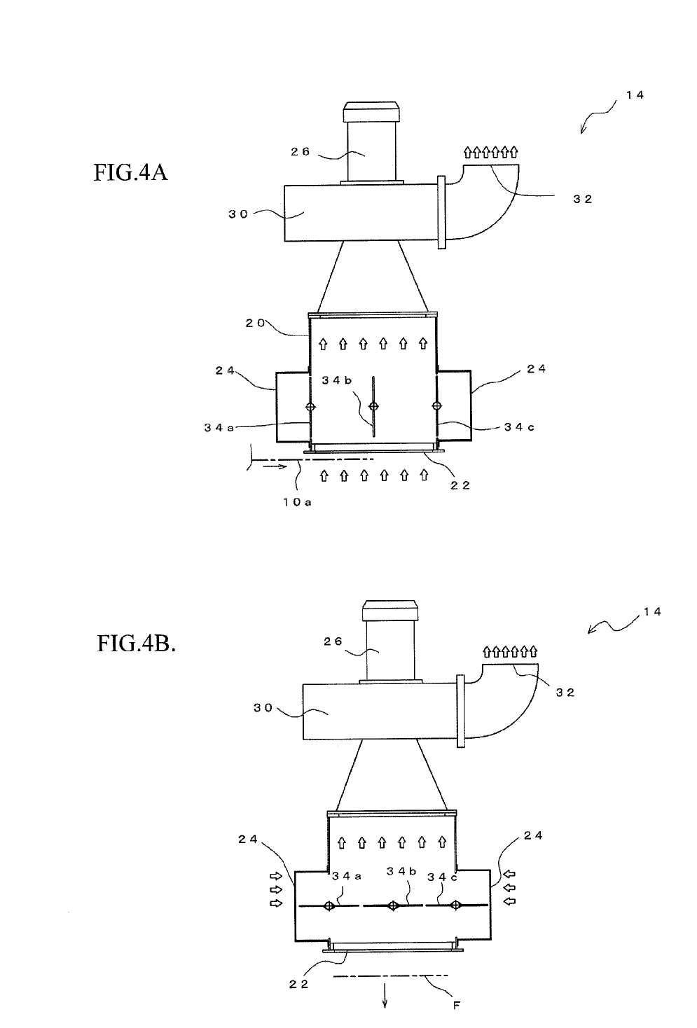

The control section 46 controls the servo motor 40 shown in FIG. 3 to synchronize with the action of the cutter of the press unit 12 (see FIG. 1), which cuts the elongated pieces to form the heat exchange fins. For example, when the elongated piece 10a of the metal thin plate 10 is fed into the sucking section 22 from the press unit 12 as shown in FIG. 4A, the control section 46 controls the servo motor 40 so as to turn the rotary blocking plates 34a, 34b and 34c until they are perpendicularly placed with respect to the sucking section 22 as shown in FIG. 4A. When the rotary blocking plates 34a, 34b and 34c are perpendicularly placed with respect to the sucking section 22 and stopped, air suction from the opening sections 24 is stopped and air can be sucked from the sucking section 22 only. Therefore, the elongated piece 10a can be sucked and held by the sucking section 22.

Next, when the elongated piece 10a is cut and formed into the heat exchange fin F having the prescribed length by the cutter of the press unit 12 as shown in FIG. 4B, the control section 46 controls the servo motor 40 so as to turn the rotary blocking plates 34a, 34b and 34c until they are paralleled with respect to the sucking section 22. When the rotary blocking plates 34a, 34b and 34c are paralleled with respect to the sucking section 22 and stopped, the air suction from the sucking sections 22 is stopped and air can be sucked from the opening sections 24. Therefore, the heat exchange fin F sucked and held by the sucking section 22 is released and falls into the stacking unit 18 by own weight.

Note that, the heat exchange fin F may be compulsorily released from the sucking section 22.

In the suction unit 14 shown in FIGS. 2 and 3, by rotating the rotary blocking plates 34a, 34b and 34c by the servo motor 40, the rotary blocking plates 34a, 34b and 34c can be moved between sucking positions, at which the elongated piece 10a can be sucked, and releasing positions, at which the heat exchange fin F can be released.

With this structure, unlike the blocking plates 118 of the conventional suction unit 108 (see FIG. 6), the rotary blocking plates 34a, 34b and 34c can be easily turned and stopped quickly. Therefore, the press unit 12 can be operated at high speed.

Further, unlike the conventional suction unit 108 in which the blocking plates 118 contact the inner face of the cylindrical member 114, the rotary blocking plates 34a, 34b and 34c can be rotated without contacting not only the adjacent rotary blocking plates but also the inner circumferential face of the cylindrical member 20. Therefore, the problems of the conventional suction unit 108 (i.e., durability, noise) can be solved.

When the opening sections 24 are closed by the rotary blocking plates 34a and 34c as shown in FIG. 4A, small gaps are formed between the rotary blocking plates 34a and 34c and inner faces of the opening sections 24. On the other hand, when the air suction from the sucking sections 22 is stopped by the rotary blocking plates 34a, 34b and 34c as shown in FIG. 4B, small gaps are formed between the rotary blocking plates 34a, 34b and 34c.

However, air leakage from the gaps shown in FIGS. 4A and 4B is much smaller than an amount of air discharged by the exhaust fan 28, so no problems occurs.

In the suction unit 14 shown in FIGS. 1-4B, three rotary blocking plates 34a, 34b and 34c are provided, but two rotary blocking plates 34a and 34c, which are capable of closing the opening sections 24, may be provided.

Further, three blocking plates, which can be swung in the same direction indicated by arrows of dotted lines, may be used instead of the rotary blocking plates 34a, 34b and 34c. In this case, three swingable blocking plates may be swung by changing the rotational direction of the servo motor 40. The change of the rotational direction of the servo motor 40 can be controlled by the control section 46.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A suction unit, which is used in a heat exchange fin manufacturing machine cutting a band-shaped metal thin plate to form into heat exchange fins having a prescribed length, each of which has a plurality of collared through-holes, and which feeds the heat exchange fins to a stacking unit,
comprising:
a cylindrical member having a sucking section, which is opened at a prescribed position, at which an elongated piece formed by cutting the band-shaped metal thin plate can face the sucking section, and which is capable of sucking the elongated piece having faced the sucking section, an opening section being opened at a prescribed position, at which the elongated piece is prohibited to face the opening section, and a suction unit for sucking air from the sucking section and the opening section;
a blocking plate being moved, by an electric motor, without contacting said cylindrical member, said blocking plate prohibiting the air suction from the opening section so as to suck the elongated piece by the sucking section when the elongated piece faces the sucking section, said blocking plate allowing the air suction from the opening section so as to feed the heat exchange fin to the stacking unit when the elongated piece sucked by the sucking section is cut and formed into the heat exchange fin having the prescribed length; and
a control section controlling the electric motor so as to place said blocking plate at a sucking position when the elongated piece faces the sucking section and at a releasing position when the elongated piece is cut and formed into the heat exchange fin.

2. The suction unit according to claim 1,
wherein said blocking plate is capable of opening and closing the opening section.

3. The suction unit according to claim 1,
wherein a plurality of said blocking plates are provided and synchronously moved.

4. The suction unit according to claim 1,
wherein said blocking plate is rotated.

5. The suction unit according to claim 4,
wherein said blocking plate is rotated in one direction.

6. The suction unit according to claim 1,
wherein said blocking plate is swung.

7. The suction unit according to claim 1,
wherein the electric motor is a servo motor.

8. A heat exchange fin manufacturing machine,
comprising:
a press unit forming a plurality of collared through-holes in a band-shaped metal thin plate and cutting the band-shaped metal thin plate to form into heat exchange fins having a prescribed length;
a stacking unit stacking the heat exchange fins; and
a suction unit feeding the heat exchange fins to said stacking unit,
wherein said suction unit comprises:
a cylindrical member having a sucking section, which is opened at a prescribed position, at which an elongated piece formed by cutting the band-shaped metal thin plate can face the sucking section, and which is capable of sucking the elongated piece having faced the sucking section, an opening section being opened at a prescribed position, at which the elongated piece is prohibited to face the opening section, and a suction unit for sucking air from the sucking section and the opening section;
a blocking plate being moved, by an electric motor, without contacting said cylindrical member, said blocking plate prohibiting the air suction from the opening section so as to suck the elongated piece by the sucking section when the elongated piece faces the sucking section, said blocking plate allowing the air suction from the opening section so as to feed the heat exchange fin to the stacking unit when the elongated piece sucked by the sucking section is cut and formed into the heat exchange fin having the prescribed length; and
a control section controlling the electric motor so as to place said blocking plate at a sucking position when the elongated piece faces the sucking section and at a releasing position when the elongated piece is cut and formed into the heat exchange fin.
